(19) United States
(12) Patent Application Publication
(10) Pub. No.: US 2021/0349692 A1
(43) Pub. Date: Nov. 11, 2021

(54) MULTIPLIER AND MULTIPLICATION METHOD

(71) Applicant: Xiamen SigmaStar Technology Ltd., Fujian (CN)

(72) Inventors: Chao LI, Zhubei City (TW); Bo LIN, Zhubei City (TW); Wei ZHU, Zhubei City (TW)

(21) Appl. No.: 17/146,946

(22) Filed: Jan. 12, 2021

(30) Foreign Application Priority Data
Apr. 22, 2020 (CN) 202010322268.2

(51) Int. Cl. G06F 7/544; G06N 3/04

(52) U.S. Cl. CPC G06F 7/5443; G06N 3/04

(57) ABSTRACT

A multiplier includes a multiplier preprocessing circuit, an encoding code, an addition circuit and a partial product selection circuit. The multiplier preprocessing circuit generates different input coding values from a received multiplier according to different operation bit widths. The encoding circuit generates different coded values according to different input coding values, and performs an operation according to different coded values and a received multiplicand to obtain a first partial product. The addition circuit accumulates the first partial product for a corresponding number of times according to different operation bit widths to generate different second partial products. The multiplier supports multiplication of multiple mixed bit widths, and a multiplier unit can be repeatedly used for multiplication operations in encounters with different precisions.

This application claims the benefit of China application Serial No. CN202010322268.2, filed Apr. 22, 2020, the subject matter of which is incorporated herein by reference.

### BACKGROUND OF THE INVENTION

### Field of the Invention

The invention relates to the technical field of multiplication, and more particularly to a multiplier and a multiplication method

### Description of the Related Art

Deep learning is one critical application technology for developing artificial intelligence, and is extensively applied in fields including computer vision and voice recognition. Convolutional neural networking (CNN) is a deep learning efficient recognition technology that has drawn much attention in the recent years. It performs convolutional operations and vector operations of multiple layers with multiple feature filters by directly inputting original image or data, further generating highly accurate results in aspects of imaging and voice recognition. The scale of filters can range from small-block scales such as 1×1 and 3×3 to 5×5 and 7×7 or even 11×11 large-scale convolution operation blocks, and thus the convolution operation is also a quite performing-consuming operation.

The processing of signals in a computer usually includes numerous complex operations, which can be decomposed into combinations of addition and multiplication. Taking a convolution operation in a neural network for example, data access, addition and multiplication need to be performed for a number of times for one convolution operation, so as to finally realize the convolution operation.

A conventional adder performs addition of an augend and an addend one bit after another, and a conventional multiplier performs multiplication by first multiplying each bit in a multiplicand and a multiplier and then summing all the obtained results by shifting and an adder. Despite that the conventional adder and multiplier above are capable of achieving highly accurate calculation results, a mechanism using such adder and multiplier brings extremely long delay and high power consumption with respect to an application involving a great amount of calculation, such as a neural network. A neural network includes multiple network layers, which perform such as convolution and other complex operations for an input of the neural network or an output of a previous network, so as to calculate by the multiple network layers final corresponding results of learning, classification, recognition and processing with respect to the output of the network layer. It is understandable that, the amount of calculation of the multiple network layers in a neural network is enormous. Moreover, such calculation frequently needs to utilize results of calculation executed earlier in time, and the use of the conventional adder and multiplier occupy vast resources in a processor of a neural network, leading to extremely long delay and high power consumption.

A large amount of convolution operation needs to be performed in an Al processor, the number of multiply-accumulate (MAC) arrays greatly influences the performance of an Al processor, and calculation precisions for operands during operation are different, for example, some operations are 8-bit multiplication, some are 16-bit multiplication and some are even 2-bit multiplication. Thus, a multiplier is a crucial functional unit in an Al processor, and how to design and optimize a multiplier and reduce timing path delay of a multiplier are keys for enhancing the performance of an Al processor; in encounters with multiplication of different precisions, how to repeatedly use a multiplier unit as much as possible and reduce hardware resource consumption are keys to reducing the chip area of an Al processor.

### SUMMARY OF THE INVENTION

It is an object of the present invention to provide a multiplier and a multiplication method at least solve one of the technical problems of the prior art.

A multiplier is provided according an aspect of the present invention. The multiplier includes a multiplier preprocessing circuit, an encoding circuit, an addition circuit and a partial production selection circuit. The multiplier preprocessing circuit generates at least one input coding value according to an operation bit width and a multiplier. The encoding circuit generates at least one coded value according to the input coding value, and performs an operation according to the coded value and a multiplicand to obtain at least one first partial product. The addition circuit accumulates the first partial product for a corresponding number of times according to the operation bit width to generate at least one second partial product. The partial product selection circuit selectively selects, from the first partial product and the second partial product according to an output bit width, a corresponding partial product as a target partial product.

A multiplication method is provided according to another aspect of the present invention. The multiplication method includes: generating at least one input coding value according to an operation bit width and a multiplier; generating at least one coded value according to the input coding value, and performing an operation according to the coded value and a multiplicand to obtain at least one first partial product; accumulating the first partial product for a corresponding number of times according to the operation bit width to generate at least one second partial product; and selectively selecting, from the first partial product and the second partial product according to an output bit width, a corresponding partial product as a target partial product.

The multiplier and the multiplication method according to the embodiments of the present invention can support multiplication of multiple mixed bit widths, and support multiplication mixed with or without a sign. In terms of hardware area, the area of one multiplier is far less than the area of several multipliers respectively corresponding to different data bit widths, thus significantly reducing hardware cost. In terms of hardware consumption, the power consumption of one multiplier is also far less than the power consumption of several multipliers respectively corresponding to different data bit widths. In encounters with multiplication of different precisions, the multiplication unit can be repeated used to reduce hardware resource consumption. For such as a neural network in which an enormous amount of convolution operations and operations including multiple combinations of complex multiplication and addition need to be performed, delay as well as power consumption can be effectively reduced.

### BRIEF DESCRIPTION OF THE DRAWINGS

FIG. 1 is a structural block diagram of a multiplier according to an embodiment of the present invention;

FIGS. 2A and 2B together, and connected via lines L1-L12, show a structural schematic diagram of a multiplier according to another embodiment of the present invention;

FIG. 3 is a flowchart of a multiplication method according to another embodiment of the present invention; and

FIG. 4 is a structural schematic diagram of an operation device according to another embodiment of the present invention.

### DETAILED DESCRIPTION OF THE INVENTION

Details of the present invention are further given in the specific embodiments with the accompanying drawings below for a person skilled in the art to better understand the technical solution of the present invention.

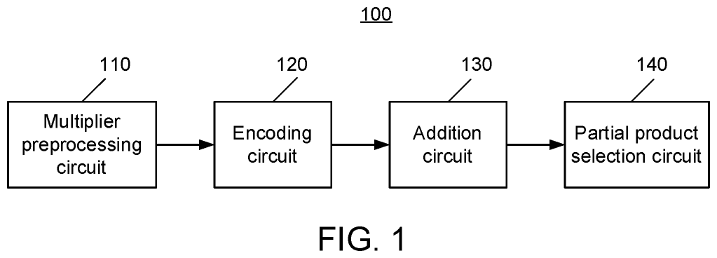

A multiplier according to an embodiment of the present invention is described with reference to FIG. 1

As shown in FIG. 1, a multiplier 100 includes a multiplier preprocessing circuit 110, an encoding circuit 120, an addition circuit 130 and a partial product selection circuit 140. The multiplier preprocessing circuit 110 generates different input coding values from a received multiplier according to different operation bit widths. The encoding circuit 120 generates different coded values according to different input coding values, and performs an operation according to the different coded values and a received multiplicand to obtain a first partial product. The addition circuit 130 accumulates the first partial product for a corresponding number of times according to the different operation bit widths to generate different second partial products. The partial product selection circuit 140 selectively selects, from the first partial product and the different second partial products according to a received output bit width, and outputs a corresponding partial product as a target partial product. For example, if the operation bit width is 2-bit, the output bit width may be 2-bit. For another example, if the operation bit width is 4-bit, the output bit width may be 2-bit or 4-bit. Further, if the operation bit width is 16-bit, the output bit width may be 2-bit, 4-bit, 8-bit or 16-bit. That is to say, the output bit width is less than or equal to the operation bit width. The operation bit width of multiplication that can be processed by the multiplier is preferably 2ⁿ, and may also be capable of processing multiplication of other multi-bit operations.

The multiplier of this embodiment is capable of realizing multiplication of multiple operation bit widths; further, hardware structures corresponding to each operation bit width are not necessary, and processing of multiple bit widths can be implemented with the aid of a multiplier preprocessing circuit provided, thereby simplifying hardware resource consumption and enhancing multiplication efficiency of the multiplier.

For example, the multiplier preprocessing circuit 110 may generate sequentially placed multiple sets of sub-input coding values from the received multiplier according to the different operation bit widths m and a predetermined coding base n, wherein the first set of sub-input coding value includes a fixed zero bit and a multiplier bit, the remaining sets of sub-input coding values include respective selection bits and multiplier bits, the multiplier bit is determined according to the multiplier, and the selection bit is determined according to the operation bit width.

Specifically, decomposing the input coding values into sequentially placed multiple sets of sub-input coding values according to the operation bit width m and the predetermined coding base n is specifically grouping the input coding values by taking the bit count of (n−1) as one set, wherein the input coding values include a total of m/(n−2) sets of sub-input coding values, and the multiple sets of sub-input coding values are sequentially placed from the first set to the last set. The coding base n is selected according to actual conditions, for example, 4, 5 or 6 may be selected as the base n. Further, the first set of sub-input coding value includes a fixed zero bit and a multiplier bit, and the remaining sub-input coding values include respective selection bits and multiplier bits.

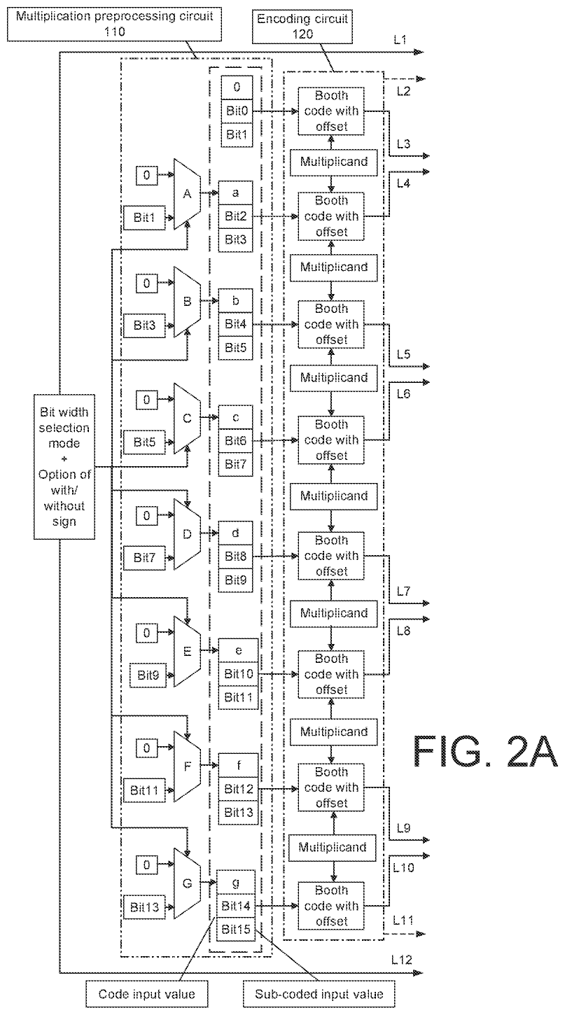

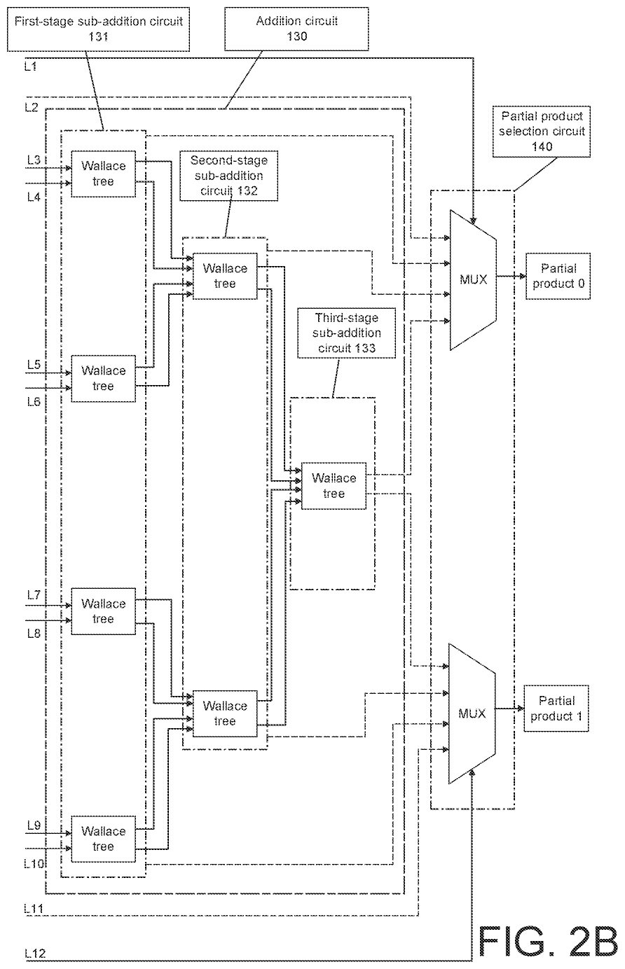

For example, as shown in FIGS. 2A and 2B, the coding base in this embodiment is valued as 4, and so the input coding values are grouped into multiple sets of sub-input coding values by taking every 3 bits as one set. If the operation bit width is selected to be 16-bit, the input coding values include a total of 8 sets of sub-input coding values; if the operation bit width selected to be 8-bit, the input coding values include a total of 4 sets of sub-input coding values; if the operation bit width is selected to be 2-bit, the input coding values include a total of 1 set of sub-input coding value.

After the multiple sets of sub-input coding values have been determined, the multiplier bit and the selection bit of each of the sets of sub-input coding values need to be determined, with associated details as specifically given below.

For example, the multiplier bit is determined according to a multiplier bit value and the operation bit width; that is, the multiplier is sequentially placed into the multiplier bit of each set of sub-input coding value according to the bit count of the sub-input coding values, wherein the order for placing the multiplier is sequentially from a less significant bit to a more significant bit. In this embodiment, as shown in FIGS. 2A and 2B, if the received multiplier is a 2-bit multiplier, the first bit and the second bit of the multiplier are respectively placed to the second bit and the third bit of the first set of sub-input coding value. Because the least significant bit of the first sub-input coding value is the first bit, which is the fixed zero bit, the second bit is then the multiplier bit at the least significant bit, thereby implementing the sequential placement. In contrast, if the received multiplier is a 4-bit multiplier, the first bit and the second bit of the multiplier are respectively placed to the second bit and the third bit of the first set of sub-input coding value, the third bit and the fourth bit of the multiplier are respectively placed to the second bit and the third bit of the second set of sub-input coding value, thereby implementing the sequential placement. The similar allocation approach is used for the multipliers for the remaining operation bit widths.

For example, to determine the selection bit of each set of sub-input coding value, the selection bit corresponding to one set of sub-input coding value needs to be generated according to the different operation bit widths. For example, the selection bit of the second set of sub-input coding value may be the most significant bit of the first set of sub-input coding value, or the selection bit of the second set of sub-input coding value may also be zero, depending on the current operation bit. For example, when the operation bit width is 2-bit, the selection bit of the second set of sub-coed input values is zero. When the current operation bit width is 4-bit, the selection bit of the second set of sub-input coding value is the most significant bit of the first set of sub-input coding value. For another example, when the current operation bit width is 8-bit, the selection bit of the second set of sub-input coding value is the most significant bit of the first set of sub-input coding value, the selection bit of the third set of sub-input coding value is the most significant bit of the second set of sub-input coding value, and so forth. Apart from the allocation approach above, a person skilled in the art may also select other allocation approaches according to actual requirements, and such is not limited by the embodiment.

For example, a specific structure of the multiplier preprocessing circuit may be as shown in FIGS. 2A and 2B, wherein the multiplier preprocessing circuit 110 further includes at least one selector, and each selector generates the selection bit corresponding to one set of sub-input coding value according to the operation bit width. The selector may be in one or multiple in quantity. When there are multiple selectors, the multiple selectors are connected in a cascade, and each selector corresponds to one set of sub-input coding value among the remaining sets of sub-input coding values; that is, the first set of sub-input coding value is not provided with a corresponding selector. The number of the selectors is determined according to a maximum value k of the operation bit width and the coding base n, and is specifically k/(n−2)−1.

In this embodiment, the maximum value k of the operation bit width is 16-bit and the coding base n is 4, and so the number of selectors is 7, that is, a total of 7 selector A, B, C, D, E, F and G in FIGS. 2A and 2B, wherein the 7 selectors are cascaded. In a specific utilization process, the 7 selectors are not necessarily used altogether, but may be used according to the operation bit width and the number of multiplication needing parallel processing. For example, to process multiplication of one 16-bit multiplier and multiplicand, 7 selectors need to be used; to process multiplication of eight 2-bit multipliers and multiplicands, 7 selectors need to be used; to process multiplication of four 2-bit multipliers and multiplicands, only 3 selectors need to be used; to process multiplication of three 4-bit multipliers and multiplicands, only 5 selectors need to be used.

For example, when the operation bit width is a predetermined high operation bit width, the selector further uses, according to the high operation bit width, a multiplier bit at a more significant bit in a previous set of sub-input coding value of the sub-input coding value corresponding to the current selector as the selection bit of the corresponding set of sub-input coding value. When the operation bit width is a predetermined low operation bit width, the selector further uses, according to the low operation bit width, the fixed zero bit as the selection bit of the corresponding set of sub-input coding value.

It should be noted that, for each selector, the low operation bit width and the high operation bit are not necessarily one in quantity, and the low operation bit width and the high operation bit width are merely relative. For example, a 2-bit operation bit width is a low operation bit width for the selector A to the selector G. In contrast, a 4-bit operation bit width is a high operation bit width for the selectors A, C and E, but is a low operation bit width for the selectors B, D and F; and so forth.

In this embodiment, the predetermined high operation bit widths and low operation bit widths with respect to the 7 selectors are specifically as follows:

A: low operation bit width: 2-bit; high operation bit width: 4-bit, 8-bit, and 16-bit.

B: low operation bit width: 2-bit and 4-bit; high operation bit width: 8-bit, and 16-bit.

C: low operation bit width: 2-bit; high operation bit width: 4-bit, 8-bit, and 16-bit.

D: low operation bit width: 2-bit, 4-bit and 8-bit; high operation bit width 16-bit.

E: low operation bit width: 2-bit; high operation bit width: 4-bit, 8-bit, and 16-bit.

F: low operation bit width: 2-bit and 4-bit; high operation bit width: 8-bit, and 16-bit.

G: low operation bit width: 2-bit; high operation bit width: 4-bit, 8-bit, and 16-bit.

Specifically, as shown in FIGS. 2A and 2B, taking the selector A for example, when the operation bit width is 2-bit, the selector A uses the fixed zero bit as the selection bit, that is, a is valued as 0. When the operation bit width is 4-bit, 8-bit or 16-bit, the selector A uses the multiplier at a more significant bit in the previous set of sub-input coding value of the sub-input coding value corresponding to the current selector (the selector A) as the selection bit. Because the selector A corresponds to the second set of sub-input coding value, the previous set of sub-input coding value is the first set of sub-input coding value, and so the multiplier bit located at a more significant bit in the first set of sub-input coding value is used as the selection bit, the selection result a outputted by the selector A is Bit1, and Bit1 is used as the selection bit of the set of sub-input coding value (the second set of sub-input coding value) corresponding to the selector A; that is, the selection bit of the second set of sub-input coding value is Bit1.

Taking the selector B for example, when the operation bit width is 2-bit or 4-bit, that is, the operation bit width is the predetermined low bit width of the selector B, the selector B uses the fixed zero bit as the selection bit, that is, b is valued as 0. When the operation bit width is 8-bit or 16-bit, that, is, the operation bit width is the predetermined high operation bit width of the selector B, the selector B uses the multiplier bit located at a more significant bit in the previous set of sub-input coding value of the sub-input coding values corresponding to the current selector (the selector B) as the selection bit. Because the selector B corresponds to the third set of sub-input coding value, the previous set of sub-input coding value is the second set of sub-input coding value, and so the multiplier bit located at a more significant bit in the second set of sub-input coding value is used as the selection bit, the selection result b outputted by the selector B is Bit3, and Bit3 is used as the selection bit of a set of sub-input coding value (the third set of sub-input coding value) corresponding to the selector B; that is, the selection bit of the third set of sub-input coding value is Bit3.

The operation principle of other selectors are the same and is omitted herein. It should be noted that, the configuration details of the high operation bit widths and the low operation bit widths of the selectors are merely examples for illustration purposes. Since the selectors set forth by the embodiment are preferably used for processing multiplication of an operation bit width of 2ⁿ, only examples of 2ⁿ operation bit widths are described with respect to the configuration details of the high operation bit width and the low operation bit width, and it does not mean that the multiplier set forth by the embodiment is capable of only processing multiplication of 2ⁿ operation bit widths, and values of the high operation bit width and the low operation bit width may also be set to such as 3-bit, 6-bit and 15-bit.

In this embodiment, booth encoding is preferably used, and so the encoding circuit 120 is preferably implemented by a booth encoding module. Generating different coded values according to different input coding values by the encoding circuit is specifically generating different booth coded values according to different booth input coding values. Further, the booth encoding module generates different booth coded values carrying different fixed offsets according to the different input coding values, wherein the fixed offset corresponds to the operation bit width.

The booth coded value carrying a fixed offset is primarily for coding multiplication with a sign, wherein the fixed offset is determined by the design of the multiplier. In this embodiment, the fixed offset of a booth coded value generated according to each sub-input coding value is −1. For example, for the multiplier of this embodiment processing 8-bit multiplication, since four 2-bit partial products of multiplication need to be accumulated, the offset of each of the booth coded values generated from four sets of 3-bit sub-input coding values is −1. Thus, the cumulative offset of the four booth coded values is binary 16′b0101_0101_0000_0000, which is hexadecimal 16′h5500; similarly, the offset of 16-bit multiplication is 32′h5555_0000, the offset of 4-bit multiplication is 8′h50, and the offset of 2-bit multiplication is 4′h4.

The booth encoding module utilized in the multiplier of this embodiment is different from a conventional booth encoding method. In this embodiment, the coding result generated by the booth encoding module carries a fixed offset, which provides a benefit of having a reduced circuit area that is smaller than the area of conventional booth encoding.

For example, as shown in FIGS. 2A and 2B, the encoding circuit 120 includes multiple encoding sub-circuits. For example, the encoding circuit may include 8 encoding sub-circuits, each of which being used for receiving and processing one sub-input coding value. During the operation of the encoding circuit 120, the multiplicand is first decomposed according to the sub-input coding value, so that the decomposed multiplicand corresponds to the multiplier bit. In this embodiment, the multiplicand is decomposed in groups of two bits in each to obtain multiple sets of sub-multiplicands, the multiple encoding sub-circuits then perform a parallel operation on the corresponding sub-multiplicands using the sub-input coding values to generate multiple first partial sub-products, and the multiple first partial sub-products are outputted as the first partial product.

In the multiplier of this embodiment, performing multiplication on the received multiplicand using the booth coded values to obtain the first partial product is specifically the booth encoding module performing an operation on the received multiplicand according to the different booth coded values to obtain the first partial product; that is, multiple booth encoding sub-circuits performing a parallel operation on the corresponding sub-multiplicands using the multiple sub-input coding values to generate multiple first partial sub-products, wherein the number of the first partial sub-products is the same as and one-on-one corresponds to the number of sets of the sub-input coding values.

In this embodiment, each sub-input coding value is 3-bit since the booth encoding base is 4. Thus, each sub-input coding value is 2-bit, the multiplicand is decomposed into sub-multiplicand in groups of 2 bits each, each encoding sub-circuit can perform parallel encoding on the corresponding 2-bit sub-multiplicand using the 2-bit sub-input coding value to obtain a 4-bit first partial sub-product, and multiple 4-bits first partial sub-products together form the first partial product. That is, each first partial sub-product is an operation result of the 2-bit multiplier and 2-bit multiplicand, i.e., each first partial sub-product is a 4-bit value.

For example, as shown in FIGS. 2A and 2B, the addition circuit 130 accumulates the first partial product for a corresponding number of times according to different operation bit widths to generate different second partial products. The addition circuit may be a circuit capable of implementing an addition function, and a Wallace tree addition module is used in this embodiment.

Specifically, as shown in FIGS. 2A and 2B, the addition circuit includes multi-stage addition sub-circuits. The stages of the sub-addition circuits is determined according to the maximum value k of the operation bit width, and is specifically log₂^{k}−1. In this embodiment, the maximum k of the operation bit width is 16-bit, and so the addition circuit of this embodiment includes three stages of sub-addition circuits. As shown in FIGS. 2A and 2B, the addition circuit 130 includes a first-stage sub-addition circuit 131, a second-stage sub-addition circuit 132 and a third-stage sub-addition circuit 133. The encoding circuit 120 is selectively connected to the first-stage sub-addition circuit 131 and the partial product selection circuit 140, the first-stage sub-addition circuit 132 is selectively connected to the second-stage sub-addition circuit 132 and the partial product selection circuit 140, the second-stage sub-addition circuit 132 is selectively connected to the third-stage sub-addition circuit 133 and the partial product selection circuit 140, and the third-stage sub-addition circuit 133 is connected to the partial product selection circuit 140.

Further, each sub-addition circuit 130 includes at least one addition unit, which is for specifically implementing addition. The number of addition units in the first-stage sub-addition circuit 131 is ½ of the number of the encoding sub-circuits, i.e., ½ of the number of the first partial sub-products. That is to say, every two first partial sub-products outputted by the encoding circuit 120 are correspondingly inputted into one addition unit of the first-stage sub-addition circuit 131, and each addition unit performs addition on every two first partial sub-products and outputs multiple first-stage second partial sub-products to obtain a first-stage second partial product. The number of addition units in the second-stage sub-addition circuit 132 is ½ of the number of the addition units in the first-stage sub-addition circuit 131, and each addition unit performs addition on every two first-stage second partial sub-products and outputs multiple second-stage second partial sub-products to obtain a second-stage second partial product. The number of addition units in the third-stage sub-addition circuit 133 is ½ of the number of addition units in the second-stage sub-addition circuit 132, and each addition unit performs addition on every two second-stage second partial sub-products and outputs multiple third-stage second partial sub-products to obtain a third-stage second partial product.

In this embodiment, the addition circuit is implemented by a Wallace tree addition circuit. The Wallace tree addition circuit includes multi-stage Wallace sub-addition circuits, each of which including multiple Wallace tree addition units. As shown in FIGS. 2A and 2B, the first-stage sub-addition circuit 131 includes four addition units, the second-stage sub-addition circuit 132 includes two addition circuits, and the third-stage sub-addition circuit 133 includes one addition unit, wherein the addition units are Wallace tree addition units.

The multi-stage sub-addition circuits respectively selectively output multi-stage second partial products; the first-stage sub-addition circuit 131 selectively accumulates the inputted first partial products to output first-stage second partial products, the second-stage sub-addition circuit 132 selectively accumulates the inputted first-stage second partial products to output second-stage second partial products, and the third-stage sub-addition circuit 133 selectively outputs the inputted second-stage second partial products to output a third-stage second partial product. In this embodiment, since the first partial product is a partial product of 2-bit multiplication, i.e., a partial product of 4 bits, if the multi-stage sub-addition circuits respectively selectively output multi-stage second partial products, the first-stage second partial product is a partial product of 4-bit multiplication, i.e., a partial product of 8 bits, the second-stage second partial product is a partial product of 8-bit multiplication, i.e., a partial product of 16 bits, and the third-stage second partial product is a partial product of 16-bit multiplication, i.e., a partial product of 32 bits.

The encoding circuit outputs the first partial product to the partial product selection circuit, and the multi-stage sub-addition circuits respectively selectively output the multi-stage second partial products to the partial product selection circuit. In this embodiment, the first-stage sub-addition circuit selectively outputs the first-stage second partial products to the partial product selection circuit, the second-stage sub-addition circuit selectively outputs the second-stage second partial products to the partial product selection circuit, and the third-stage sub-addition circuit selectively outputs the third-stage second partial product to the partial product selection circuit.

The multi-stage sub-addition circuits being selectively connected to the partial product selection circuit, or alternatively speaking, the multi-stage sub-addition circuits selectively outputting refers to the multi-stage sub-addition circuits selectively outputting the second partial products according to the operation bit width, is specifically that, when the operation bit width is a predetermined addition bit width of the multi-stage sub-addition circuits, the first-stage sub-addition circuits are connected to the encoding circuit, or the multi-stage sub-addition circuits are connected to the respective previous-stage sub-addition circuits, and the multi-stage sub-addition circuits output the corresponding multi-stage second partial products; otherwise, the first-stage sub-addition circuits are not connected to the encoding circuit, or the multi-stage sub-addition circuits are not connected to the respective previous-stage sub-addition circuits, and the multi-stage sub-addition circuits do not perform any output. The predetermined addition bit width may be specifically configured according to actual utilization conditions.

In this embodiment, the predetermined addition bit widths of the first-stage sub-addition circuits are 4-bit, 8-bit and 16-bit, the predetermined addition bit widths of the second-stage sub-addition circuits are 8-bit and 16-bit, and the predetermined addition bit width of the third-stage sub-addition circuit is 16-bits.

If the operation bit width is 2-bit, the first-stage sub-addition circuits, the second-stage sub-addition circuits and the third-stage sub-addition circuit are not connected to the partial product selection circuit, and do not output the second partial products; the encoding circuit is not connected to the first-stage sub-addition circuits, and only the encoding circuit outputs the first partial product to the partial product selection circuit.

If the operation bit width is 4-bit, the first-stage sub-addition circuits are not connected to the second-stage sub-addition circuits, and the second-stage sub-addition circuits and the third-stage sub-addition circuit are not connected to the partial product selection circuit, and the second-stage sub-addition circuits and the third-stage sub-addition circuit do not output the second partial products; the encoding circuit is connected to the first-stage sub-addition circuits, and the first-stage sub-addition circuits are selectively connected to the partial product selection circuit and output first-stage second partial products.

If the operation bit width is 8-bit, the second-stage sub-addition circuits are not connected to the third-stage sub-addition circuit, and the third-stage sub-addition circuit is not connected to the partial product selection circuit and does not output the second partial product; the encoding circuit is selectively connected to the first-stage sub-addition circuits, and the first-stage sub-addition circuits are selectively connected to the partial product selection circuit and output the first-stage second partial products; the first-stage sub-addition circuits are selectively connected to the second-stage sub-addition circuits, and the second-stage sub-addition circuits are selectively connected to the partial product selection circuit and output the second-stage second partial products.

If the operation bit width is 16-bit, the encoding circuit is selectively connected to the first-stage sub-addition circuits, and the first-stage sub-addition circuits are selectively connected to the partial product selection circuit and output the first-stage second partial products; the first-stage sub-addition circuits are selectively connected to the second-stage sub-addition circuits, and the second-stage sub-addition circuits are selectively connected to the partial product selection circuit and output the second-stage second partial products; the second-stage sub-addition circuits are selectively connected to the third-stage sub-addition circuit, and the third-stage sub-addition circuit is selectively connected to the partial product selection circuit and outputs the third-stage second partial product.

Moreover, the multiplier preprocessing circuit further generates different input coding values from the received multiplier according to different sign information received. The different sign information is information with or without a sign.

If the sign information is a multiplier with a sign and a multiplicand with a sign, the multiplier performs multiplication of the multiplier with a sign and the multiplicand with a sign, the multiplier preprocessing circuit generates input coding values with sign information from the received multiplier with a sign, the encoding circuit generates different coded values having a fixed offset according to the input coding values with sign information, and performs an operation on the received multiplicand with a sign according to the different coded values having a fixed offset to obtain the first partial product.

Specifically, the generating the booth coded values having the fixed offset is adding 0 to the sign bit in the booth input coding values generated from the booth input coding value with the sign information. For example, when the sub-input coding value is 100 and a booth coded value correspondingly generated is −2, 0 is added to the sign bit of −2 instead of expressing by 1 in a negative sign, wherein the bit width of the sign bit is determined according to the operation bit width. The above design saves hardware resources and reduces logic delay. At this point, the first partial product includes an output value and a carry value, wherein the output value is one or more multiples of the multiplicand obtained according to the coded value, and the carry value is a sign of the first partial product obtained according to the coded value, i.e., a positive sign or a negative sign. In this embodiment, the output value is determined according to the booth coded value having a fixed offset and the non-sign bit of the product obtained from the received multiplicand, and the carry value is obtained according to the booth coded value having a fixed offset and the sign bit of the product obtained from the received multiplicand.

Moreover, the second partial product includes an output value and a carry value, wherein the output value is one or more multiples of the multiplicand obtained according to the coded value, and the carry value is the sign of the second partial product obtained according to the first partial product, i.e., a positive sign or a negative sign.

If the sign information is a multiplier with a sign and a multiplicand without a sign, the operation process of the multiplier is the same as that when the sign information is a multiplier with a sign and a multiplicand with a sign, and only differs in that, the sign bit of the multiplicand needs to be expanded. Specifically, 0 is added to the more significant bits of the multiplier and the multiplicand according to the operation bit width, so that the bit widths of the multiplicand and the multiplier are the same, and then multiplication is performed.

If the sign information is a multiplier without a sign and a multiplicand without a sign, the multiplier performs multiplication on the multiplier without a sign and the multiplicand without a sign, the multiplier preprocessing circuit generates a input coding value without sign information from the received multiplier without a sign, and the encoding circuit generates different coded values according to the input coding value without sign information and performs an operation on the received multiplicand without a sign according to the different coded values to obtain the first partial product. In addition, while multiplication is being performed, the sign bits of the multiplier and the multiplicand are expanded, and specifically, 0 is added to the more significant bits of the multiplier and the multiplicand according to the operation bit width to obtain sign expanded bits.

Moreover, the encoding circuit further includes a sign expansion encoding sub-circuit, which encodes the sign expansion bits of the multiplier without a sign and outputs a sign expansion bit coded value, and performs an operation on the multiplicand according to the sign expansion bit coded value. In this embodiment, the expansion encoding sub-circuit is a booth expansion encoding sub-circuit, which processes a sub-input coding value that is merely 000 or 001, has a simple logic and occupies resources far less than those of a normal booth encoder. Thus, hardware resources are effectively saved by processing multiplication with a sign using the method above.

The partial product selection circuit 140 selectively selecting from the first partial product and the different second partial products and outputting the target partial product corresponding to the different operation bit widths is specifically, the partial product selection circuit selecting from the first partial product and the different second partial products according to the received output bit width and outputting a partial product having a bit width the same as the output bit width, as the target partial product. The second partial products include multi-stage second partial products, and are the first-stage second partial products, the second-stage second partial products and the third-stage partial product in this embodiment.

Moreover, the partial product selection circuit 140 includes a first partial product selection sub-circuit and a second partial product selection sub-circuit. The first partial product selection sub-circuit selectively selects from the first partial product output value and the different second partial product output values and outputs a partial product output value corresponding to the different output bit widths, as a target partial output value. The second partial product selection sub-circuit selectively selects from the first partial product carry value and the different second partial product carry values and outputs a corresponding partial product carry value corresponding to the different output bit widths, as a target partial product carry value. As shown in FIGS. 2A and 2B, in this embodiment, the first partial product selection sub-circuit and the second partial product selection sub-circuit are implemented by multiplexers (MUX).

It is known in combination with FIGS. 2A and 2B that, the multiplier preprocessing circuit in the multiplier set forth by the embodiment includes 7 selectors. The encoding circuit may implement multiplication by booth encoding, and the booth encoding base is 4. The addition circuit implements addition by a Wallace tree, and has three stages of sub-addition circuits—the first-stage sub-addition circuit includes four Wallace tree addition units, the second-stage sub-addition circuit includes two Wallace tree addition units, and the third-stage sub-addition circuit includes one Wallace tree addition unit. The partial product selection circuit uses two multiplexers to respectively select the output values and the carry values of the first partial product and the different second partial products.

When the multiplier set forth by the embodiment is used to perform one 16-bit multiplication, i.e., the operation bit width is selected as 16-bit, the multiplier and the multiplicand are both 16-bit, the coding base is 4, and the input coding values are grouped by every 3 bits in a total of 8 sets.

The 16 bits of the multiplier are respectively inputted into multiplier bits Bit0 to B15 in the input coding value in FIGS. 2A and 2B; that is, in two multiplier bits in the 8 sets of coded sub-input values, values of the multiplier bits in the input coding values are assigned. The least significant bit of the first set of sub-input coding value is a fixed 0 bit, and the seven selectors A to G respectively perform selection and determination according to the 16-bit operation bit width. Because the 16-bit operation bit width is a predetermined high operation bit width of the seven selectors, the seven selectors output the multiplier bits at the more significant bits in the previous set of sub-input coding value of the sub-input coding values corresponding to the selectors as the selection bits; that is, the seven selectors respectively output Bit1, Bit3, Bit7, Bit9, Bit11 and Bit13 as the selection bits in the second set of sub-input coding value, hence completing assigning values to the selection bits in the input coding values. Once values have been assigned to the multiplier bits and the selection bits, the input coding value including 8 sets of sub-input coding values is then generated. The 8 sets of sub-input coding values from most significant bits to least significant bits are specifically as follows.

The first set is: {bit0, bit0, 0}.

The second set is {bit3, bit2, a}, where a is a value generated by the A^{th} selector, and A=0 if the operation bit width of multiplication is 2-bit, and A=bit1 if the operation bit width of multiplication is 4/8/16-bit. Since the operation bit width is 16-bit, A=bit1.

The third set is {bit5, bit4, b}, where b is a value generated by the Bt^{th} selector, B=0 if the operation bit width of multiplication is 2/4-bit, and B=bit3 if the operation bit width of multiplication is 8/16-bit. Since the operation bit width is 16-bit, B=bit3.

The fourth set is {bit7, bit6, c}, where c is a value generated by the C^{th} selector, C=0 if the operation bit width of multiplication is 4/8/16-bit, and C=bit5 if the operation bit width of multiplication is 16-bit. Since the operation bit width is 16-bit, C=bit5.

The fifth set is {bit9, bit8, d}, where d is a value generated by the D^{th} selector, D=0 if the operation bit width of multiplication is 2/4/8-bit, and D=bit7 if the operation bit width of multiplication is 16-bit. Since the operation bit width is 16-bit, D=bit7.

The sixth set is {bit11, bit10, e}, where e is a value generated by the E^{th} selector, E=0 if the operation bit width of multiplication is 2-bit, and E=bit9 if the operation bit width of multiplication is 4/8/16-bit. Since the operation bit width is 16-bit, E=bit9.

The seventh set is {bit13, bit12, f}, where f is a value generated by the F^{th} selector, F=0 if the operation bit width of multiplication is 2/4-bit, and F=bit11 if the operation bit width of multiplication is 8/16-bit. Since the operation bit width is 16-bit, F=bit11.

The eighth set is {bit15, bit14, g}, where g is a value generated by the G^{th} selector, G=0 if the operation bit width of multiplication is 2-bit, and G=bit13 if the operation bit width of multiplication is 4/8/16-bit. Since the operation bit width is 16-bit, G=bit13.

The input coding value is inputted into the encoding circuit. The multiplicand is first decomposed according to the sub-input coding value, so that the decomposed multiplicand corresponds to the multiplier bit, as shown in FIGS. 2A and 2B; that is, the multiplicand is decomposed according in groups of two bits each to obtain multiple sets of sub-multiplicands. In this embodiment, 8 sets of sub-multiplicands are in fact obtained, and FIGS. 2A and 2B depicts merely an example for illustration. Parallel multiplication is performed on the corresponding sub-multiplicands using the sub-input coding values to generate 8 first partial sub-products, and the 8 first partial sub-products are outputted. Each of the first partial sub-product is a 4-bit partial product obtained from multiplication of the 2-bit multiplier and the 2-bit multiplicand, and the 8 first partial sub-products are the first partial product.

Because the 16-bit operation bit width is the predetermined addition bit width of the first-stage sub-addition circuit, the encoding circuit is connected to the first-stage sub-addition circuit, the first-stage sub-addition circuit is connected to the partial product selection circuit, the first partial product is inputted into the first-stage sub-addition circuit, and the four Wallace tree addition units in the first-stage sub-addition circuit respectively perform addition on every two of the 8 first partial sub-products to output four sets of 4-bit addition results, that is, 4 sets of 8-bit partial products, which are the first-stage second partial products.

Because the 16-bit operation bit width is the predetermined addition bit width of the second-stage sub-addition circuit, the first-stage sub-addition circuit is connected to the second-stage sub-addition circuit, the second-stage sub-addition circuit is connected to the partial product selection circuit, the first-stage second partial products are inputted into the second-stage sub-addition circuit, and the two Wallace tree addition units in the second-stage sub-addition circuit respectively perform addition on every two of the 4 sets of 8-bit partial products in the first-stage second partial products to output 2 sets of 8-bit addition results, that is, 2 sets of 16-bit partial products, which are the second-stage second partial products.

Because the 16-bit operation bit width is the predetermined addition bit width of the third-stage sub-addition circuit, the second-stage sub-addition circuit is connected to the third-stage sub-addition circuit, the third-stage sub-addition circuit is connected to the partial product selection circuit, the second-stage second partial products are inputted into the third-stage sub-addition circuit, and the 1 Wallace tree addition unit in the third-stage sub-addition circuit performs addition on every two of the 2 sets of 16-bit partial products in the second-stage second partial products to output 1 set of 16-bit addition result, that is, 1 set of 32-bit partial product, which is the third-stage second partial product.

The encoding circuit outputs 4-bit partial products to the partial product selection circuit, the first-stage sub-addition circuit outputs the 8-bit partial products to the partial selection circuit, the second-stage sub-addition circuit outputs the 16-bit partial products to the partial product selection circuit, and the third-stage sub-addition circuit outputs a 32-bit partial product to the partial product selection circuit.

The partial product selection circuit selects, from the first partial product and multiple second partial products according to the output bit width selected by a bit width selection circuit and outputs, a partial product having a bit width the same as the output bit width, as the target partial product; that is, the partial product selection circuit selects from the 4-bit partial product, the 8-bit partial product, the 16-bit partial product and the 32-bit partial product a partial product having a bit width the same as the output bit width, as the target partial product. If the output bit width is 2-bit, the 2-bit partial product is selected and outputted as the target partial product; if the output bit width is 4-bit, the 4-bit partial product is selected and outputted as the target partial product; if the output bit width is 8-bit, the 8-bit partial product is selected and outputted as the target partial product; if the output bit width is 16-bit, the 16-bit partial product is selected and outputted as the target partial product; if the output bit width is 32-bit, the 32-bit partial product is selected and outputted as the target partial product.

The multiplier set forth in this embodiment supports concurrent operations of 8 2×2-bit sets to provide a result of 4-bit data for each set, supports concurrent operations of 4 4×4-bit sets to provide a result of 8-bit data for each set, supports concurrent operations of 2 8×8-bit sets to provide a result of 16-bit data for each set, and supports concurrent operations of 1 16×16-bit set to provide a result of 32-bit data for each set. It is also discovered from the above that, the multiplier is 16-bit, the multiplicand is 16-bit, and the partial products are individually 32-bit, and so compatibility is provided for both input and output ports of hardware regardless of which bit width is used. Moreover, on the basis of the data bit width above, an option of supporting a sign bit is further provided; that is, support is provided for a multiplier that is a value with a sign and a multiplicand that is a value with a sign, for a multiplier that is a value without a sign and a multiplicand that is a value with a sign, and for a multiplier that is a value without a signal and a multiplicand that is a value without a sign.

In conclusion of the above, the multiplier set forth in the embodiment realizes operations for multiplication of different bit widths, and outputs target partial products of multiplication of different bit widths.

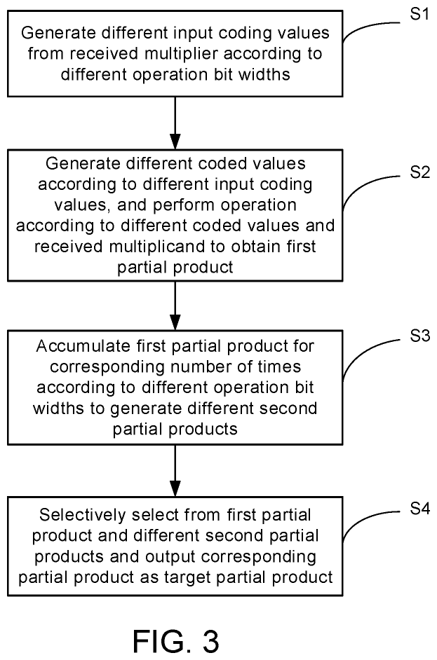

A multiplication method according to another embodiment of the present invention is described with reference to FIG. 3 below. The multiplication method may be applied for an artificial intelligence processor. In practice, the multiplication method may be implemented by the multiplier described above, and specific details may be referred from the foregoing literature and are omitted herein.

As shown in FIG. 3, a multiplication method includes steps of: S1, generating different input coding values from a received multiplier according to different operation bit widths; S2, generating different coded values according to different input coding values, and performing an operation according the different coded values and a received multiplicand to generate a first partial product; S3, accumulating the first partial product for a corresponding number of times according to the different operation bit widths to generate different second partial products; and S4, selectively selecting from the first partial product and the different second partial products according to a received output bit width and outputting a corresponding partial product, as a target partial product.

The multiplication method further includes, before step S1, step S0: selecting a bit width mode, specifically, selecting an operation bit width and selecting an output bit width, wherein the output bit width is less than or equal to the operation bit width. Further, in step S0, the selecting a bit width mode further includes selecting sign information.

In step S1, the multiplier preprocessing circuit 110 generating different input coding values from the received multiplier according different operation bit widths is specifically: generating sequentially placed multiple sets of sub-input coding values from the received multiplier according to the different operation bit widths and a predetermined coding base, wherein the first set of sub-input coding value includes a fixed zero bit and a multiplier bit, and the remaining sets of sub-input coding values include respective selection bits and multiplier bits; determining the multiplier bit of each set of sub-input coding value according to the multiplier; and determining the selection bit of each set of sub-input coding value according to the operation bit width.

In step S2, the encoding circuit 120 generating different coded values according to different input coding values. In this embodiment, the encoding circuit 120 uses one booth encoding module, that is, generating different booth coded values carrying different fixed offsets according to the different input coding values, wherein the fixed offset corresponds to the operation bit width.

In step S2, the performing an operation according to the different coded values and a received multiplicand to obtain a first partial product is specifically: decomposing the multiplicand according to the sub-input coding value so that the decomposed multiplicand corresponds to the multiplier bit, and in this embodiment, decomposing the multiplicand in groups of two bits each to obtain multiple sets of sub-multiplicands; performing parallel multiplication on the corresponding sub-multiplicands using the sub-input coding value to generate multiple first partial sub-products; and obtaining a first partial product according to the multiple first partial sub-products, wherein the number of first partial sub-products is the same as and one-on-one corresponds to the number of the sub-input coding values.

In step S3, the addition circuit 130 accumulating the first partial product for a corresponding number of times according to the different operation bit widths to generate different second partial products is specifically: determining whether the operation bit is the same as a predetermined multi-stage addition bit width, and performing accumulation of a current stage if so to obtain a current-stage second partial product, otherwise not performing accumulation if not. The performing accumulation of a current stage is specifically performing accumulation for multiple times, i.e., accumulating every two first partial sub-products or accumulating every two multi-stage second partial sub-products. In this embodiment, the multi-stage second partial products include first-stage second partial products, second-stage second partial sub-products and third-stage second partial sub-products. In this embodiment, the accumulation is performed using a Wallace tree method.

In step S4, the partial production selection circuit 140 selectively selecting from the first partial product and the different second partial products and outputting a corresponding partial product as a target product is specifically: the partial product selection circuit selecting, from the first partial product and the different second partial product according to a received output bit width and outputting a partial product having a bit width same as a received output bit width, as a target partial product. The second partial product includes multi-stage second partial products, is first-stage second partial products, second-stage second partial products and third-stage second partial products in this embodiment.

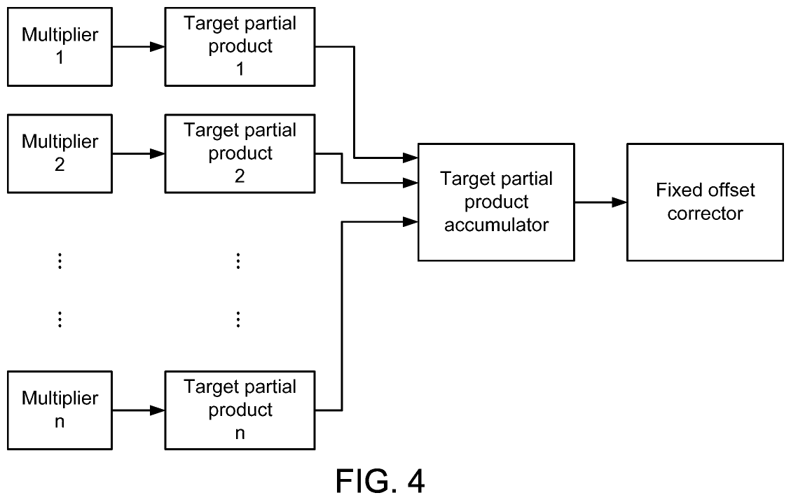

An operation device according to another embodiment of the present invention is described with reference to FIG. 4 below.

As shown in FIG. 4, the operation device includes the multiplier disclosed in the first embodiment, and further includes a target partial product accumulator and a fixed offset corrector.

The target partial product accumulator accumulates the target partial product outputted by the multiplier to generate a multiplication result carrying a fixed offset.

The fixed offset corrector corrects the fixed offset of the multiplication result carrying the fixed offset to obtain a multiplication result.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. A multiplier, comprising:
a multiplier preprocessing circuit, generating at least one input coding value according to an operation bit width and a multiplier;
an encoding circuit, generating at least one coded value according to the input coding value, and performing an operation according to the coded value and a multiplicand to obtain at least one first partial product;
an addition circuit, accumulating the first partial product for a corresponding number of times according to the operation bit width to generate at least one second partial product; and
a partial product selection circuit, selectively selecting, from the first partial product and the second partial product according to an output bit width, a corresponding partial product as a target partial product.

2. The multiplier according to claim 1, wherein the multiplier preprocessing circuit generates the input coding value according to the operation bit width and a predetermined coding base, the input coding value comprises a plurality of sets of sub-input coding values, and at least one set of the plurality of sets of sub-input coding values comprises a selection bit and a multiplier bit; wherein, the multiplier preprocessing circuit determines the multiplier bit according to the multiplier, and determines the selection bit according to the operation bit width.

3. The multiplier according to claim 2, wherein the multiplier preprocessing circuit further comprises a selector, and the selector corresponds to the set of sub-input coding value comprising the selection bit and the multiplier bit and selects the selection bit according to the operation bit width.

4. The multiplier according to claim 3, wherein when the operation bit width is a high operation bit width, the selector uses the multiplier bit at a more significant bit in a previous set of sub-input coding value of the corresponding set of sub-input coding value as the selection bit according to the high operation bit width; when the operation bit width is a low operation bit width, the selector uses a fixed zero bit as the selection bit according to the low operation bit width.

5. The multiplier according to claim 1, wherein the encoding circuit comprises a booth encoding module that generates a booth coded value having a fixed offset according to the input coding value, and the fixed offset corresponds to the operation bit width.

6. The multiplier according to claim 1, wherein the addition circuit comprises:
a first-stage sub-addition circuit, a second-stage sub-addition circuit and a third-stage sub-addition circuit;
wherein, the first-stage sub-addition circuit is selectively connected to the second-stage sub-addition circuit and the partial product selection circuit, the second-stage sub-addition circuit is selectively connected to the third-stage sub-addition circuit and the partial product selection circuit, and the third-stage sub-addition circuit is connected to the partial product selection circuit.

7. The multiplier according to claim 1, wherein the multiplier preprocessing circuit generates the input coding value further according to received sign information.

8. A multiplication method applied for an artificial intelligence processor, comprising:
generating at least one input coding value according to an operation bit width and a multiplier;
generating at least one coded value according to the input coding value, and performing an operation according to the coded value and a multiplicand to obtain at least one first partial product;
accumulating the first partial product for a corresponding number of times according to the operation bit width to generate at least one second partial product; and
selectively selecting, from the first partial product and the second partial product according to an output bit width, a corresponding partial product as a target partial product.

9. The multiplication method according to claim 8, wherein the step of generating at least one input coding value according to an operation bit width and a multiplier comprises:
generating the input coding value according to the operation bit width and a predetermined coding base, wherein the input coding value comprises a plurality of sets of sub-input coding values, and at least one set of the plurality of sets of sub-input coding values comprises a selection bit and a multiplier bit;
wherein, the multiplier bit is determined according to the multiplier, and the selection bit is determined according to the operation bit width.

10. The multiplication method according to claim 8, wherein the step of generating at least one coded value according to the input coding value comprises:
generating a booth coded value comprising a fixed offset according to the input coding value, the fixed offset corresponding to the operation bit width.
